(19) United States
(12) Patent Application Publication
(10) Pub. No.: US 2025/0145115 A1
(43) Pub. Date: May 8, 2025

(54) Retractable Cowl Panel Cover for a Vehicle

(71) Applicant: Karma Automotive LLC, Irvine, CA (US)

(72) Inventor: Nicholas David, Irvine, CA (US)

(73) Assignee: Karma Automotive LLC, Irvine, CA (US)

(21) Appl. No.: 18/933,914

(22) Filed: Oct. 31, 2024

Related U.S. Application Data
(60) Provisional application No. 63/596,858, filed on Nov. 7, 2023.

(51) Int. Cl. B60S 1/04

(52) U.S. Cl. CPC B60S 1/0405

(57) ABSTRACT

A method for moving a retractable cowl cover of a vehicle between a retracted position and an extended position includes, while the retractable cowl cover is in the extended position receiving a first wiper input including an input to turn on operation of one or more windshield wipers. Based on receiving the first wiper input, the method also includes instructing at least one actuator to move the retractable cowl cover in a first direction from the extended position to the retracted position.

### CROSS-REFERENCE TO RELATED APPLICATIONS

This U.S. patent application claims priority under 35 U.S.C. § 119 (e) to U.S. Provisional Application 63/596,858, filed on Nov. 7, 2023. The disclosure of this prior application is considered part of the disclosure of this application and is hereby incorporated by reference in its entirety.

### TECHNICAL FIELD

This disclosure relates to a retractable cowl panel cover for a vehicle.

### BACKGROUND

A cowl panel of a vehicle is located at the space between a hood and windshield of a vehicle where the vehicle's windshield wipers are located. Cowl panels are infamous for collecting leaves, twigs, pine needles, and other debris to detract from the vehicle's appearance, and may further lead to interference with the vehicle's windshield wipers. Moreover, the windshield wipers are always visible from the exterior of the vehicle while resting on the cowl panel while not in use.

### SUMMARY

One aspect of the disclosure provides a computer-implemented method executing on data processing hardware of a vehicle that causes the data processing hardware to perform operations for moving a retractable cowl cover of the vehicle between a retracted position and an extended position. While the retractable cowl cover is in the extended position, the operations include: receiving a first wiper input including an input to turn on operation of one or more windshield wipers; and based on receiving the first wiper input, instructing at least one actuator to move the retractable cowl cover in a first direction from the extended position to the retracted position.

Implementations of the disclosure may include one or more of the following optional features. In some implementations, at least a portion of the retractable cowl cover is disposed underneath a hood of the vehicle when the retractable cowl cover moves into the retracted position. In some examples, the retractable cowl cover substantially conceals the one or more windshield wipers stored/stowed upon a cowl panel of the vehicle when the retractable cowl cover is in the extended position, and the retractable cowl cover provides an opening for the one or more windshield wipers to clear debris from a windshield while in use. Receiving the first wiper input including the input to turn on operation of the one or more windshield wipers may include any one of: receiving a request from a driver of the vehicle to turn on operation of the one or more windshield wipers; receiving an indication from a wiper sensor that a wiper motor is powered on; or receiving an indication from a rain sensor that rain is falling on the windshield.

In some additional implementations, the operations further include, after the at least one actuator moves the retractable cowl cover to the retracted position: receiving a second wiper input including an input to turn off operation of the one or more windshield wipers; and based on receiving the second wiper input, instructing the at least one actuator to move the retractable cowl cover in a second direction from the retracted position to the extended position. In these implementations, instructing the at least one actuator to move the retractable cowl cover in the second direction from the retracted position to the extended position may cause the retractable cowl cover to move away from a hood of the vehicle and toward a windshield of the vehicle. Moreover, instructing the at least one actuator to move the retractable cowl cover in the first direction from the extended position to the retracted position may cause the retractable cowl cover to move away from the windshield of the vehicle such that at least a portion of the retractable cowl cover is disposed underneath a hood of the vehicle.

In some examples, the vehicle includes a first fixed cowl cover portion and a second fixed cowl cover portion. The first fixed cowl cover portion is laterally disposed along one of a driver side or a passenger side of the vehicle between a hood and a windshield of the vehicle and the second fixed cowl cover portion is laterally disposed along the other one of the driver side or the passenger side of the vehicle between the hood and the windshield of the vehicle. In these examples, sides of the retractable cowl cover are disposed laterally inward from each of the first and second fixed cowl cover portions. When the retractable cowl cover is in the retracted position, an edge of the retractable cowl cover that opposes the windshield of the vehicle may not be aligned with corresponding top edges of the first and second fixed cowl cover portions that oppose the windshield of the vehicle. On the other hand, when the retractable cowl cover is in the extended position, the edge of the retractable cowl cover that opposes the windshield of the vehicle may be aligned with the corresponding edges of the first and second fixed cowl cover portions that oppose the windshield of the vehicle.

Another aspect of the present disclosure provides a vehicle including a retractable cowl cover, one or more windshield wipers, and a controller that includes data processing hardware and memory hardware in communication with the data processing hardware. The memory hardware stores instructions that when executed on the data processing hardware causes the data processing hardware to perform operations that include, while the retractable cowl cover is in the extended position: receiving a first wiper input including an input to turn on operation of one or more windshield wipers; and based on receiving the first wiper input, instructing at least one actuator to move the retractable cowl cover in a first direction from the extended position to the retracted position.

This aspect of the disclosure may include one or more of the following optional features. In some implementations, the vehicle further includes a hood, wherein at least a portion of the retractable cowl cover is disposed underneath the hood of the vehicle when the retractable cowl cover moves into the retracted position. In some examples, the vehicle further includes a windshield and a cowl panel configured to store/stow the one or more windshield wiper. In these examples, the retractable cowl cover substantially conceals the one or more windshield wipers stored/stowed upon the cowl panel of the vehicle when the retractable cowl cover is in the extended position, while the retractable cowl cover provides an opening for the one or more windshield wipers to clear debris from the windshield while in use. Receiving the first wiper input including the input to turn on operation of the one or more windshield wipers may include any one of: receiving a request from a driver of the vehicle to turn on operation of the one or more windshield wipers; receiving an indication from a wiper sensor that a wiper motor is powered on; or receiving an indication from a rain sensor that rain is falling on the windshield.

In some additional implementations, the operations further include, after the at least one actuator moves the retractable cowl cover to the retracted position: receiving a second wiper input including an input to turn off operation of the one or more windshield wipers; and based on receiving the second wiper input, instructing the at least one actuator to move the retractable cowl cover in a second direction from the retracted position to the extended position. In these implementations, instructing the at least one actuator to move the retractable cowl cover in the second direction from the retracted position to the extended position may cause the retractable cowl cover to move away from a hood of the vehicle and toward a windshield of the vehicle. Moreover, instructing the at least one actuator to move the retractable cowl cover in the first direction from the extended position to the retracted position may cause the retractable cowl cover to move away from the windshield of the vehicle such that at least a portion of the retractable cowl cover is disposed underneath a hood of the vehicle.

In some examples, the vehicle further includes a hood, a windshield, a first fixed cowl cover portion; and a second fixed cowl cover portion. The first fixed cowl cover portion is laterally disposed along one of a driver side or a passenger side of the vehicle between the hood and the windshield. The second fixed cowl cover portion is laterally disposed along the other one of the driver side or the passenger side of the vehicle between the hood and the windshield of the vehicle, wherein sides of the retractable cowl cover are disposed laterally inward from each of the first and second fixed cowl cover portions. In these examples, when the retractable cowl cover is in the retracted position, an edge of the retractable cowl cover that opposes the windshield of the vehicle may not be aligned with corresponding top edges of the first and second fixed cowl cover portions that oppose the windshield of the vehicle. On the other hand, when the retractable cowl cover is in the extended position, the edge of the retractable cowl cover that opposes the windshield of the vehicle may be aligned with the corresponding edges of the first and second fixed cowl cover portions that oppose the windshield of the vehicle.

The details of one or more implementations of the disclosure are set forth in the accompanying drawings and the description below. Other aspects, features, and advantages will be apparent from the description and drawings, and from the claims

### DESCRIPTION OF DRAWINGS

FIG. 1 is a schematic view of a vehicle when a retractable cowl cover is in a retracted position.

FIG. 2 is a schematic view of the vehicle when the retractable cowl cover is in an extended position.

FIG. 3 is a side view of the vehicle when the retractable cowl cover is in the retracted position.

FIG. 4A is a top view of the vehicle when the retractable cowl cover is in the retracted position.

FIG. 4B is a top view of the vehicle when the retractable cowl cover is in the extended position.

FIGS. 5-8 are schematic views of a vehicle having a retractable trunk door in an open position.

FIG. 9 is a schematic view of an example computing device that may be used to implement the systems and methods described herein.

FIG. 10 is a flowchart of an example arrangement of operations for a method of moving a retractable cowl cover between a retracted position and an extended position.

Like reference symbols in the various drawings indicate like elements.

### DETAILED DESCRIPTION

A cowl panel of a vehicle is located at the space between a hood and windshield of a vehicle where the vehicle's windshield wipers are located. Cowl panels are infamous for collecting leaves, twigs, pine needles, and other debris to detract from the vehicle's appearance, and may further lead to interference with the vehicle's windshield wipers. More specifically, the cowl panel stores wiper motor(s) and mechanical parts of the wipers, such as and link members. Moreover, exposed cowl panels typically render the windshield wipers to always be visible from the exterior of the vehicle while not in use.

Implementations herein are directed toward a retractable cowl panel cover that operates in an extended position to cover the windshield wipers when the windshield wipers are not in use and moves from the extended position to a retracted position to provide an opening for the windshield wipers to clear debris (e.g., rain, snow, ice, washer fluid, water, etc) from the windshield while in use. While in the extended position, the cowl panel cover not only restricts debris from collecting upon the cowl panel but also drastically enhances aesthetics of the vehicle by hiding the wipers and wiper components from the view of onlookers.

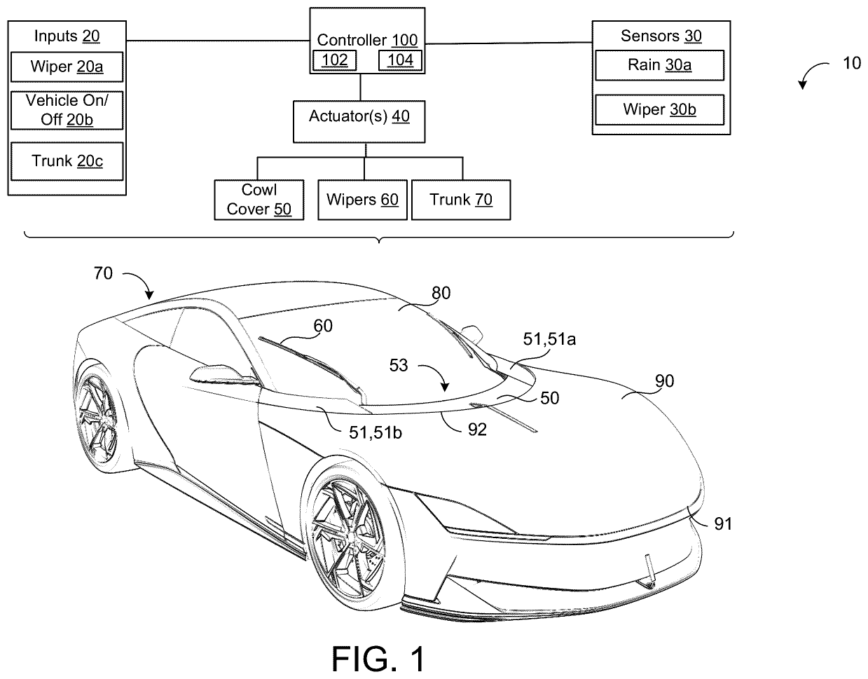

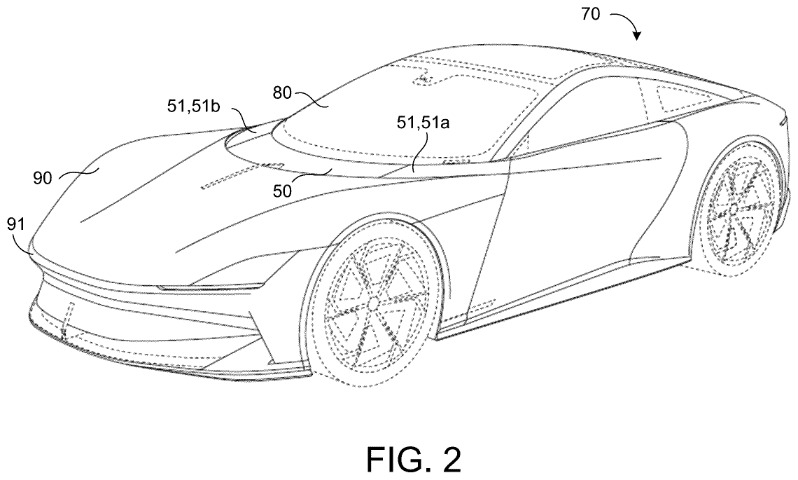

Referring to FIGS. 1 and 2, in some implementations, a vehicle 10 includes a controller 100, at least one actuator 40, a retractable cowl cover 50, one or more windshield wipers 60, and a trunk door 70. While one controller 100 is depicted, the vehicle 10 may include multiple controllers for controlling various subsystems of the vehicle 10. The vehicle 10 includes a cowl panel 53 that is situated between a windshield 80 and a hood 90. The cowl panel 53 is configured to store/house the wipers 60 and wiper components (mechanical levers, wiper motor(s), etc.). The hood 90 of the vehicle extends from a front end 91 disposed at the front of the vehicle 10 to a rear edge 92 opposing the windshield 80 and cowl panel 53. The vehicle 10 may include fixed cowl cover portions 51a, 51b laterally disposed along respective driver and passenger sides of the vehicle between the hood 90 and the windshield 80. The fixed cowl cover portions 51 cover peripheral sides of the cowl panel 53 and always remain in a fixed position regardless of whether or not the wipers 60 are in use. Notably, the base of the wipers 60 are disposed laterally inward from each of the fixed cowl cover portions 51. The retractable cowl cover 50 is disposed above the cowl panel 53 between the hood 90 and the windshield 80, whereby sides of the retractable cowl cover 50 are disposed laterally inward of fixed cowl cover portions 51. The retractable cowl cover 50 is movable between a retracted position (FIG. 1) while the wipers 60 are in use and an extended position (FIG. 2) while the wipers 60 are not in use.

In the example shown in FIG. 1, the wipers 60 are in use and the retractable cowl cover 50 is in the retracted position to allow the wipers 60 to traverse across the windshield 80 to remove debris therefrom. While in the retracted position, the retractable cowl cover 50 is urged/moved in a direction away from the windshield 80 such that at least a portion of the retractable cowl cover 50 is disposed underneath the hood 90 proximate the rear edge 92 of the hood 90. In the example shown in FIG. 2, the wipers 60 are not in use and the retractable cowl cover 50 is in the extended position to cover/hide the wipers 60 and wiper components while stowed on the cowl panel and restrict debris from collecting upon the cowl panel. Here, the retractable cowl cover 50 while in the extended position closes the opening that was provided by the retracted position for the wipers 60 to traverse the windshield 80. Notably, the retractable cowl cover 50 moves/urges toward the windshield 80 when moving from the retracted position to the extended position. While FIG. 2 shows an edge of the retractable cowl cover 50 that opposes the windshield 80 is aligned with the corresponding edge of each fixed cowl cover portions 51a, 51b opposing the windshield 80, FIG. 1 shows the edge of the cowl cover portion 50 moving away from the windshield 80 to a position that is no longer aligned with the corresponding edges of the fixed cowl cover portions 51a, 51b

The controller 100 includes data processing hardware 102 and memory hardware 104 in communication with the data processing hardware and storing instructions that when executed on the data processing hardware 102 causes the data processing hardware 102 to perform operations. Specifically, the operations may include instructing the retractable cowl cover 50 to move between the extended and retracted positions. In response to a request to activate the wipers 60, the controller 100 may command the at least one actuator 40 to move the retractable cowl cover 50 from the extended position (FIG. 2) to the retracted position (FIG. 1) to allow the wipers 60 to traverse across the windshield 80 to remove debris therefrom. Conversely, once the wipers 60 are deactivated and no longer in use, the controller 50 may command the at least one actuator 40 to move the retractable cowl cover 50 from the retracted position (FIG. 1) to the extended position (FIG. 2) to cover/hide the wipers 60 and wiper components while stowed on the cowl panel 53 and restrict debris from collecting upon the cowl panel 53.

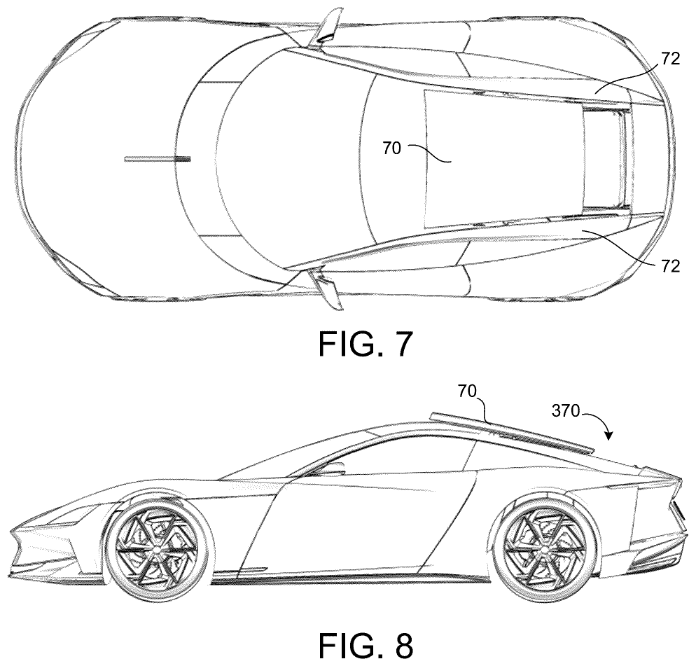

The controller 100 is in communication with a plurality of passenger inputs 20 associated with operating the vehicle 10. The passenger inputs 20 may include, without limitation, a wiper input 20a, a vehicle on/off input 20b, and a trunk open/close input 20c. The wiper input 20a may include an input for turning on operation of the wipers 60 and for turning off operation of the wipers 60. The wiper input 20a includes an input for tuning on operation of the wipers 60 may include different speeds (e.g., intermittent, low, medium, high, etc.) for operating the wipers. For instance, a driver may touch/press a button and/or manipulate a lever disposed proximate the steering wheel to provide the wiper input 20a. Optionally, the driver may provide the wiper input 20a via selection of a graphical element displayed on a graphical user interface within the vehicle. The driver could also provide the wiper input 20a via a spoken command or predefined gesture. The wiper input 20a may additionally include an input for cleaning the windshield where windshield wash fluid is projected from a nozzle (e.g., located at the cowl panel 53) onto the windshield 80 and the wipers 60 are operated for a period of time sufficient to clear the windshield the fluid. The vehicle on/off input 20b may include a vehicle ignition request to turn on (i.e., start operation of the vehicle) or turn off (i.e., stop operation of the vehicle) the vehicle 10. Described in greater detail below with reference to FIGS. 5-8, the trunk open/close input 20c may include a button/switch selected by a passenger to open or close the retractable trunk door 70 for accessing or preventing access to an interior portion (FIG. 6) of the vehicle 10. For instance, one button/switch for providing the trunk open/close input 20c may be located within the interior of the vehicle, while another button switch for providing the trunk open/close input 20c may be located outside the vehicle proximate the vehicle trunk 70. Optionally, the button/switch may include a touch pad or haptic sensor that the user my touch/press. Optionally, a gesture sensor may detect a gesture by a person to provide the trunk open/close input 20c. In some additional examples, a user may provide the trunk open/close input 20c via selection of a dedicated button on a key fob or a dedicated graphical element displayed on a user computing device (e.g., smart phone).

In some implementations, the controller 100 instructs the actuator 40 to move the retractable cowl cover 50 to the retracted position responsive to the wiper input 20a indicating a request to turn on operation of the wipers 60 and/or receiving the input for cleaning the windshield 80. On the other hand, the controller 100 may instruct the actuator 40 to move the retractable cowl cover 50 from the retracted position to the extended position responsive to receiving the wiper input 20a indicating a request to turn off operation of the wipers 60 and/or the receiving vehicle on-off input 20b for turning off the vehicle.

With continued reference to FIG. 1, the controller 100 is in communication with the plurality of vehicle sensors 30 that each provide data indicative of operation of the vehicle 10. The controller 100 uses the data received from the vehicle sensors 30 to determine whether the retractable cowl cover 50 should be in the retracted position (FIG. 1) or the extended position (FIG. 2). A rain sensor 30a may indicate whether rain is falling on the windshield, and may further classify how fast the rain is falling. Measurements by the rain sensor 30a may indicate a speed for operating the wipers 60 when the wipers 60 are enabled for automatic operation, i.e., via the wiper input 20a. The controller 100 may instruct the actuator 40 to move the retractable cowl cover 50 from the extended position to the retracted position when the rain position sensor 30a indicates rain is falling. The vehicle sensors 30 may also include a wiper sensor 30b that indicates whether or not a wiper motor is powered on to move the wipers 60. The controller 100 may instruct the actuator 40 to move the retractable cowl cover 50 to the retracted position when the rain sensor 30a indicates rain is falling and/or the wiper sensor 30b indicates the wiper motor is powered on. Similarly, the controller 100 may instruct the actuator 40 to move the retractable cowl cover 50 to the extended position when the rain sensor 30a indicates no rain is falling and/or the wiper sensor 30b indicates the wiper motor is unpowered.

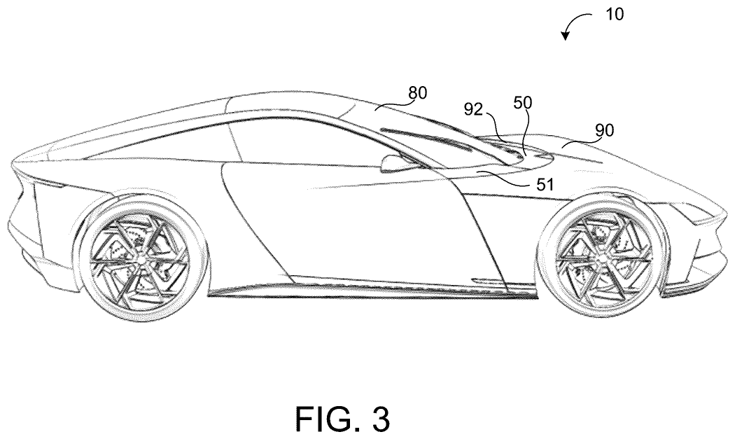

FIG. 3 shows a side view of the vehicle 10 while the retractable cowl cover 50 is in the retracted position and the wipers 60 are in use. Notably, a top surface of the retractable cowl cover 50 is recessed relative a panel of the hood 90 such that at least a portion of the retractable cowl cover 50 slides underneath the hood 90 proximate the rear edge 92 of the hood 90 when the retractable cowl cover 50 is in the retracted position.

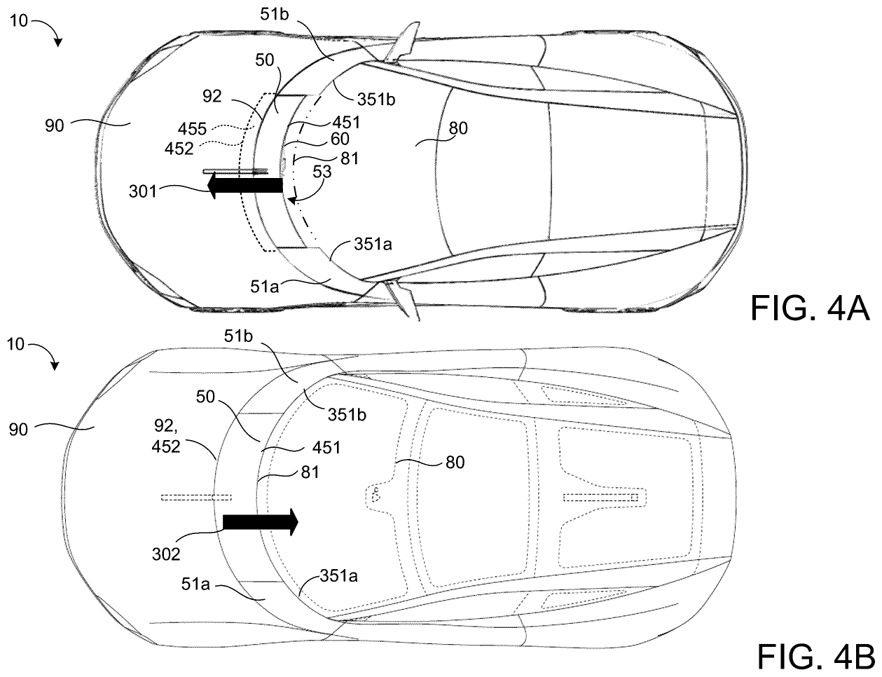

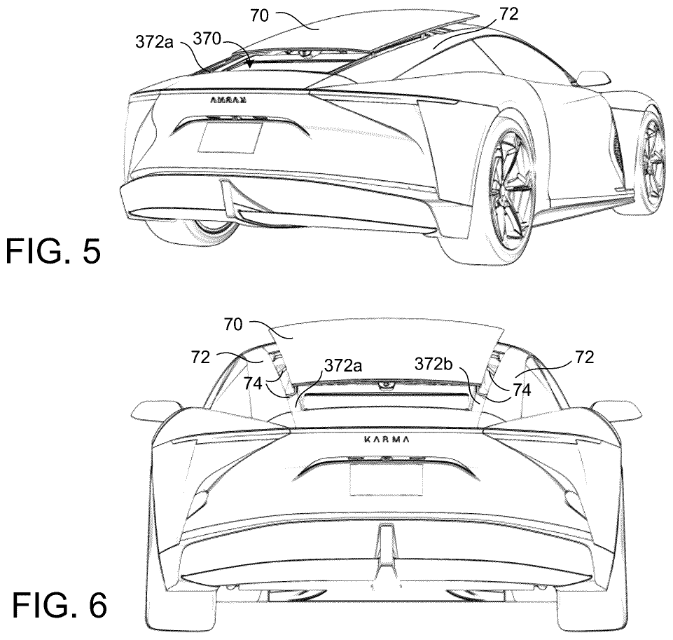

FIGS. 4A and 4B show top views of the vehicle 10 while the retractable cowl cover 50 is in the retracted position (FIG. 4A) and in the extended position (FIG. 4B). The retractable cowl cover 50 moves relative to the fixed cowl cover portions 51a, 51b and the hood 90 when the at least one actuator 40 actuates the retractable cowl cover 50 to move: in a first direction 301 from the extended position to the retracted position; and in a second direction 302 from the retracted position to the extended position. Generally, the first direction 301 is in a direction away from the windshield 80 and toward the hood 90, while the second direction 302 is in an opposite direction away from the hood 90 and toward the windshield 80. The retractable cowl cover 50 is longitudinally disposed between the windshield 80 and the hood 90 along the longitudinal direction of the vehicle 10. The retractable cowl cover 50 may be laterally disposed between the driver side (e.g., first) fixed cowl cover portion 51a and the passenger side (e.g., second) fixed cowl cover portion 51b. The fixed cowl cover portions 51a, 51b each define a corresponding top edge 351a, 351b that is generally aligned with a peripheral edge 81 of the windshield 80 that opposes the hood 90.

The retractable cowl cover 50 includes a top edge 451 that opposes the windshield 80 and a bottom edge 452 disposed on an opposite side of the cowl cover 50 than the top edge 451 that opposes the hood 90. Referring to FIG. 4A, when the retractable cowl cover 50 moves into the retracted position, the bottom edge 452 (depicted dashed hidden lines) of the retractable cowl cover 50 slides underneath the hood 90 along the rear edge 92 such that at least a portion 455 of the retractable cowl cover 50 is covered by the hood 90. Moreover, while in the retracted position, the retractable cowl cover 50 defines the opening between the top edge 451 of the cowl cover 50 and the peripheral edge 81 of the windshield 80 that exposes the cowl panel 53 to permit the wipers 60 to move across the windshield 80. Here, the top edge 451 of the retractable cowl cover 50 is offset in the first direction 301 relative to the corresponding top edges 351a, 351b of the fixed cowl cover portions 51b and the peripheral edge 81 of the windshield 80 to define the opening for when the wipers 60 are in use. FIG. 4A shows the windshield wipers 60 exposed through the opening while stowed/stored in the cowl panel 53.

Referring to FIG. 4B, when the retractable cowl cover 50 moves into the extended position, the top edge 451 of the cowl cover 501 is substantially aligned with the peripheral edge 81 of the windshield 80 and the corresponding top edges 351a, 351b of the fixed cowl cover portions 51a, 51b. As such, the opening that exposed the cowl panel 53 in FIG. 4A is substantially closed, thereby providing a cover over the cowl panel 53 that effectively hides the wipers 60 from onlookers and prevents debris from collecting on the cowl panel 53. Moreover, while in the extended position, the bottom edge 452 of the retractable cowl cover 50 traverses in the second direction 302 and into substantial alignment with the rear edge 92 of the hood 90. In some examples, the retractable cowl cover 50 still includes a portion covered by the hood 90 while in the extended position, however any portion that remains covered by the hood is less than the portion 455 (FIG. 4A) covered by the hood 90 while in the retracted position.

The at least one actuator 40 may include a linear actuator, rotational actuator, a pulley-based actuator, or any other type of actuator configured to actuate the retractable cowl cover 50 to move in the first and second directions 301, 302, respectively. The actuator 40 may include shape memory alloy material that when energized causes the actuator 40 to change its shape for actuating the retractable cowl cover 50 in one of the first direction 301 or the second direction 302. On the contrary, when the actuator 40 is no longer energized, the material of the shape memory alloy reverts back to its prior shape for actuating the retractable cowl cover 50 in the other one of the first direction 301 or the second direction 302. In some configurations, the at least one actuator 40 includes a pair of opposed pistons where a first one of the opposed pistons imparts a force that causes the retractable cowl cover 50 to move in the first direction while a second one of the opposed pistons imparts a force that causes the retractable cowl cover 50 to move in the second direction 302.

In some implementations, the retractable cowl cover 50 moves in the first and second directions 301, 302 by sliding along one or more tracks. Here, each track may be fixed to one or more stationary components and the retractable cowl cover 50 may slide along each track when moving from the extended position to the retraced position in the first direction 301 and when moving from the retracted position to the extended position in the second direction 302. In some examples, one or more rollers are coupled to the retractable cowl cover 50 and configured to roll along channels defined by the tracks. In some configurations, the tracks are fixedly attached to the retractable cowl cover 50 and are configured to engage with one or more rollers fixed to one or more stationary members of the vehicle to permit the retractable cowl cover 50 and the tracks to move in the first and second directions 301, 302 in unison relative to the rollers (and the stationary members). In some additional configurations, the one or more tracks are integrated with the retractable cowl cover 50. For instance, the one or more tracks integrated with the retractable cowl cover 50 may be defined by one or more channels formed into the retractable cowl cover 50.

Referring to FIGS. 5-8, in some implementations, the vehicle 10 includes a retractable trunk door 70 that is configured to move from a closed position (FIG. 4A) to an open position to provide access to a rear interior 370 (e.g., cargo area) of the vehicle 10. The retractable trunk door 70 may be referred to as a retractable lift gate. The retractable trunk door 70 may be formed from glass to provide a rear window. IN other configurations, the retractable trunk door 70 is opaque and may optionally include a color of the vehicle body. The vehicle 10 includes a pair of rear pillars 72 (e.g., C Pillars) that extend from the roof to the rear of the vehicle and the retractable trunk door 70 is laterally disposed between the pair of rear pillars 72. A first channel 372a is disposed laterally inward from the rear pillar 72 along the driver side and a second channel 372b is disposed laterally inward from the rear pillar 72 along the passenger side. The channels 372a, 372b define lateral sides of the rear interior 370. The channels 372a, 372b are configured to support the retractable trunk door 70

As shown in FIG. 6, each channel 372a, 372b supports a respective set of one or more hinges 74 where each hinge 74 includes a corresponding first end attached to the respective channel 372a, 372b and a corresponding second end attached to the trunk door 70 proximate a respective peripheral side of the trunk door 70. Accordingly, the hinges 74 support the trunk door 70 upon the channels 372a, 372b. The channels 372a, 372b may be recessed from the pillars 72. In some implementations, the controller 100 (FIG. 1) instructs one or more actuators 40 (FIG. 1) to move the retractable trunk door 70 to the open position to provide access to the rear interior 30. The controller 100 may instruct the actuators to move the retractable trunk door 70 to the open position responsive to receiving a trunk open/close input 20c, as described above with reference to FIG. 1. Here, the hinges 74 may be actuated to move the retractable trunk door 70 relative to the pillars 72 and the channels 372a, 372b and into the open position. Beginning from a position when the trunk door 70 is closed (as shown in FIGS. 1-4B) and exterior surfaces of the trunk door 70 are substantially flush with the rear pillars 72 and the roof, actuating the hinges may initially cause the trunk door 70 to raise upward by a distance/height relative to the pillars 72, 72 to provide sufficient clearance for sliding over a portion of the roof. Once the trunk door 70 is raised to provide the sufficient clearance, the hinges may be further actuated to cause the trunk door 70 to move into the open position by sliding away from a rear end of the vehicle and toward the roof of the vehicle. FIGS. 7 and 8 show a portion of the retractable trunk door 70 covering a rear portion of the roof when the retractable trunk door 70 is in the open position. The controller 100 may similarly instruct the one or more actuators 40 to move the retractable trunk door 70 from the open position to the closed position, whereby the hinges may be actuated to slide the trunk door 70 toward the rear end of the vehicle and then lowered to effectively close the retractable trunk door 70. The door 70 may include a latch that secure the door 70 to a rear end of the vehicle 10. When closed, peripheral edges of the door 70 may provide seals with the opposing pillars 72

In some implementations, the channels 372a, 372b define a ramped profile and the retractable trunk door 70 is supported by rollers that may roll along the channels 372a, 372b to move the retractable trunk door 70 between the open and closed positions. The at least one actuator 40 may be instructed by the controller 100 to actuate the retractable trunk door 70 between the open position and the closed position, thereby causing the rollers to traverse along the channels 372a, 372b to move the retractable trunk door 70. When moving from the closed position to the open position, the ramped profile of the channels 372a, 372b may permit the trunk door 70 to raise upward relative to the pillars 72, 72 while moving toward the roof in order to provide sufficient clearance for sliding over a portion of the roof. The present disclosure contemplates many different types of actuators and mechanisms for use in sliding the retractable trunk door 70 between the open and closed positions responsive to the controller 100 receiving an open/close trunk input 20c.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

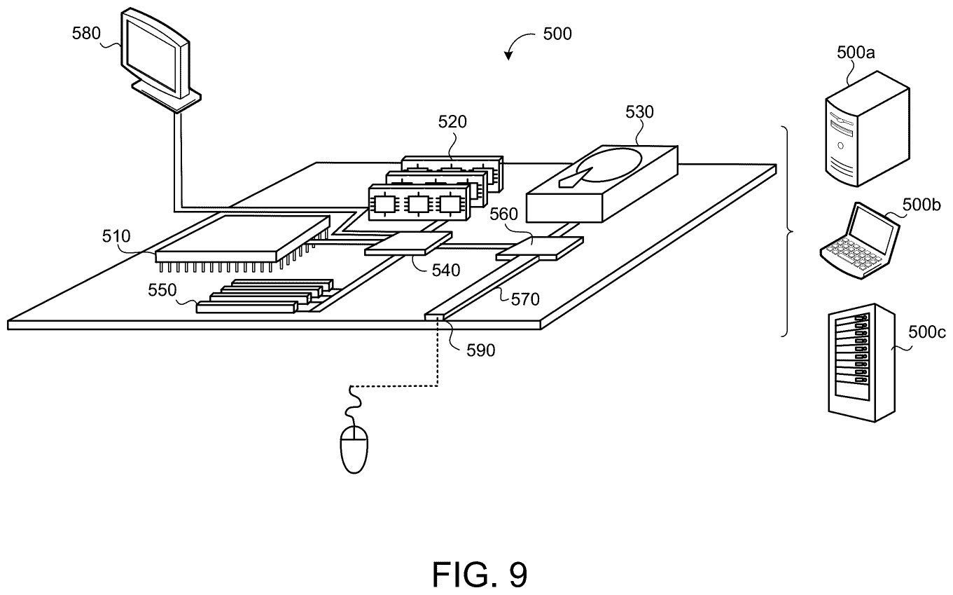

FIG. 9 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor (e.g., data processing hardware 102 of FIG. 1) 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory (e.g., memory hardware 104 of FIG. 1) 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

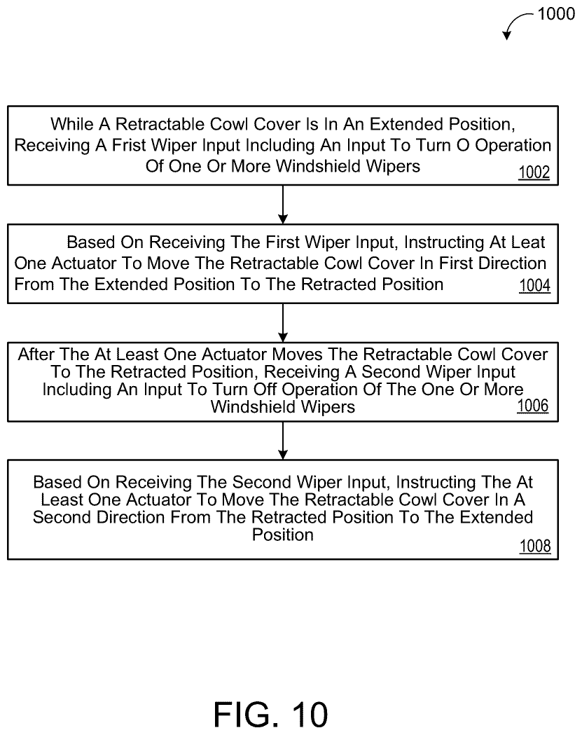

FIG. 10 is a flowchart of an example arrangement of operations for a method 1000 of moving a retractable cowl cover 50 of a vehicle 100 between a retracted position and an extended position. The flowchart of FIG. 10 may be described with reference to FIGS. 1-5B. The data processing hardware 102 of the controller 100 may perform the operations for the method 1000 by executing instructions stored on the memory hardware 104 of the controller 100. Operations 1002 and 1004 are performed while the retractable cowl cover is in the extended position. At operation 1002, the method 1000 includes receiving a first wiper input including an input to turn on operation of one or more windshield wipers 60 of the vehicle 10. At operation 1004, based on receiving the first wiper input, the method 1000 includes instructing at least one actuator 40 to move the retractable cowl cover in a first direction 301 from the extended position to the retracted position.

Operations 1006 and 1008 are performed after the at least one actuator 40 moves the retractable cowl cover 50 to the retracted position. At operation 1006, the method 1000 includes receiving a second wiper input including an input to turn off operation of the one or more windshield wipers. At operation 1008, based on receiving the second wiper input, the method 1000 includes instructing the at least one actuator 40 to move the retractable cowl cover in a second direction 302 from the retracted position to the extended position.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware of a vehicle causes the data processing hardware to perform operations for moving a retractable cowl cover of the vehicle between a retracted position and an extended position, the operations comprising:
while the retractable cowl cover is in the extended position:
receiving a first wiper input including an input to turn on operation of one or more windshield wipers; and
based on receiving the first wiper input, instructing at least one actuator to move the retractable cowl cover in a first direction from the extended position to the retracted position.

2. The computer-implemented method of claim 1, wherein at least a portion of the retractable cowl cover is disposed underneath a hood of the vehicle when the retractable cowl cover moves into the retracted position.

3. The computer-implemented method of claim 1, wherein:
the retractable cowl cover substantially conceals the one or more windshield wipers stored/stowed upon a cowl panel of the vehicle when the retractable cowl cover is in the extended position; and
the retractable cowl cover provides an opening for the one or more windshield wipers to clear debris from a windshield while in use.

4. The computer-implemented method of claim 1, wherein the operations further comprise, after the at least one actuator moves the retractable cowl cover to the retracted position:
receiving a second wiper input including an input to turn off operation of the one or more windshield wipers; and
based on receiving the second wiper input, instructing the at least one actuator to move the retractable cowl cover in a second direction from the retracted position to the extended position.

5. The computer-implemented method of claim 4, wherein instructing the at least one actuator to move the retractable cowl cover in the second direction from the retracted position to the extended position causes the retractable cowl cover to move away from a hood of the vehicle and toward a windshield of the vehicle.

6. The computer-implemented method of claim 1, wherein instructing the at least one actuator to move the retractable cowl cover in the first direction from the extended position to the retracted position causes the retractable cowl cover to move away from a windshield of the vehicle such that at least a portion of the retractable cowl cover is disposed underneath a hood of the vehicle.

7. The computer-implemented method of claim 1, wherein:
the vehicle includes a first fixed cowl cover portion and a second fixed cowl cover portion, the first fixed cowl cover portion laterally disposed along one of a driver side or a passenger side of the vehicle between a hood and a windshield of the vehicle and the second fixed cowl cover portion laterally disposed along the other one of the driver side or the passenger side of the vehicle between the hood and the windshield of the vehicle; and
sides of the retractable cowl cover are disposed laterally inward from each of the first and second fixed cowl cover portions.

8. The computer-implemented method of claim 7, wherein, when the retractable cowl cover is in the extended position, an edge of the retractable cowl cover that opposes the windshield of the vehicle is aligned with corresponding edges of the first and second fixed cowl cover portions that oppose the windshield of the vehicle.

9. The computer-implemented method of claim 7, wherein, when the retractable cowl cover is in the retracted position, an edge of the retractable cowl cover that opposes the windshield of the vehicle is not aligned with corresponding top edges of the first and second fixed cowl cover portions that oppose the windshield of the vehicle.

10. The computer-implemented method of claim 1, wherein receiving the first wiper input including the input to turn on operation of the one or more windshield wipers comprises any one of:
receiving a request from a driver of the vehicle to turn on operation of the one or more windshield wipers;
receiving an indication from a wiper sensor that a wiper motor is powered on; or
receiving an indication from a rain sensor that rain is falling on the windshield.

11. A vehicle comprising:
a retractable cowl cover;
one or more windshield wipers; and
a controller comprising data processing hardware and memory hardware in communication with the data processing hardware, the memory hardware storing instructions that when executed on the data processing hardware causes the data processing hardware to perform operations comprising, while the retractable cowl cover is in the extended position:
receiving a first wiper input including an input to turn on operation of the one or more windshield wipers; and
based on receiving the first wiper input, instructing at least one actuator to move the retractable cowl cover in a first direction from the extended position to the retracted position.

12. The vehicle of claim 11, further comprising:
a hood,
wherein at least a portion of the retractable cowl cover is disposed underneath the hood of the vehicle when the retractable cowl cover moves into the retracted position.

13. The vehicle of claim 11, further comprising:
a cowl panel configured store/stow the one or more windshield wipers; and
a windshield,
wherein the retractable cowl cover substantially conceals the one or more windshield wipers stored/stowed upon the cowl panel of the vehicle when the retractable cowl cover is in the extended position, and
wherein the retractable cowl cover provides an opening for the one or more windshield wipers to clear debris from the windshield while in use.

14. The vehicle of claim 11, wherein the operations further comprise, after the at least one actuator moves the retractable cowl cover to the retracted position:
receiving a second wiper input including an input to turn off operation of the one or more windshield wipers; and
based on receiving the second wiper input, instructing the at least one actuator to move the retractable cowl cover in a second direction from the retracted position to the extended position.

15. The vehicle of claim 14, wherein instructing the at least one actuator to move the retractable cowl cover in the second direction from the retracted position to the extended position causes the retractable cowl cover to move away from a hood of the vehicle and toward a windshield of the vehicle.

16. The vehicle of claim 11, wherein instructing the at least one actuator to move the retractable cowl cover in the first direction from the extended position to the retracted position causes the retractable cowl cover to move away from a windshield of the vehicle such that at least a portion of the retractable cowl cover is disposed underneath a hood of the vehicle.

17. The vehicle of claim 11, further comprising:
a hood;
a windshield;
a first fixed cowl cover portion laterally disposed along one of a driver side or a passenger side of the vehicle between the hood and the windshield; and
a second fixed cowl cover portion laterally disposed along the other one of the driver side or the passenger side of the vehicle between the hood and the windshield of the vehicle,
sides of the retractable cowl cover are disposed laterally inward from each of the first and second fixed cowl cover portions.

18. The vehicle of claim 17, wherein, when the retractable cowl cover is in the extended position, an edge of the retractable cowl cover that opposes the windshield of the vehicle is aligned with corresponding edges of the first and second fixed cowl cover portions that oppose the windshield of the vehicle.

19. The vehicle of claim 17, wherein, when the retractable cowl cover is in the retracted position, an edge of the retractable cowl cover that opposes the windshield of the vehicle is not aligned with corresponding top edges of the first and second fixed cowl cover portions that oppose the windshield of the vehicle.

20. The vehicle of claim 11, wherein receiving the first wiper input including the input to turn on operation of the one or more windshield wipers comprises any one of:
receiving a request from a driver of the vehicle to turn on operation of the one or more windshield wipers;
receiving an indication from a wiper sensor that a wiper motor is powered on; or
receiving an indication from a rain sensor that rain is falling on the windshield.
